(19) United States
(12) Patent Application Publication
(10) Pub. No.: US 2003/0107164 A1
(43) Pub. Date: Jun. 12, 2003

(54) Method for producing images in the edge of a volume of paper sheets

(76) Inventor: Cristian Todie, Paris (FR)

Correspondence Address: OPPEDAHL AND LARSON LLP, P O BOX 5068, DILLON, CO, 80435-5068, US

(21) Appl. No.: 10/204,379

(22) PCT Filed: Jan. 17, 2001
(86) PCT No.: PCT/FR01/00141

(30) Foreign Application Priority Data
Feb. 17, 2000 (FR) 00/01941

(51) Int. Cl. B41F 13/58

(52) U.S. Cl. 270/5.02

(57) ABSTRACT

The present invention concerns a method for producing an image in the edge of a volume of paper sheets. The invention can be used for numerous stationary products, note pads, exercise books, and the like. In the present invention, the images are printed not on the edges but on the paper surface. The method comprises a series of steps: printing—realigning—guillotining. The invention also concerns the insertion of a segmented image, systematically in edges and added in the make-up of a volume, for use in a complex technological process.

The present invention relates to a process for making images on the side of a volume of paper sheets.

The characteristic lies in the capacity of recombining images in the section of a block of paper and combinative potential (texts or images) in anamorphisms, deformations and forms.

The invention can be applied to a series of paper products: note books, note pads, books etc . . . or to facilitate innovation of new objects and games. The contribution can also be decorative, advertising, promotional or indicative. In the past, there were impressions of texts or images on the side of books or the section of blocks of paper. In the present invention, the images are printed not on the side but on the surface of paper so as to keep coherence of the image and sufficient quantity of the image elements. The process comprises a series of steps:

1) Impression of the volume of paper recto sheets or verso (black and white, monochromy or quadrichromy), with the selected side (P1.1 FIG. a).

2) Skewing the volume of paper to an angle different than 90°, with the help of a device so that the two ends of the image are found on a common perpendicular line to the plane of the paper (P1.1 FIG. 2b).

3) Trimming the block of paper through the printed image (P1.1 FIG. 2c).

One result, the recombining of the images in the height of the volume of paper sheets which appear in the section, at least, in a theoretical way, the image will not be really and clearly visible until a shift of the sheets the ones compared to the others, or by the distorsion of the volume of the paper sheets (P1.1 FIG. a). In the case of the verso impression, one or the other image appears according to the direction of the distorsion in an alternative way (P1.1 FIG. 3b).

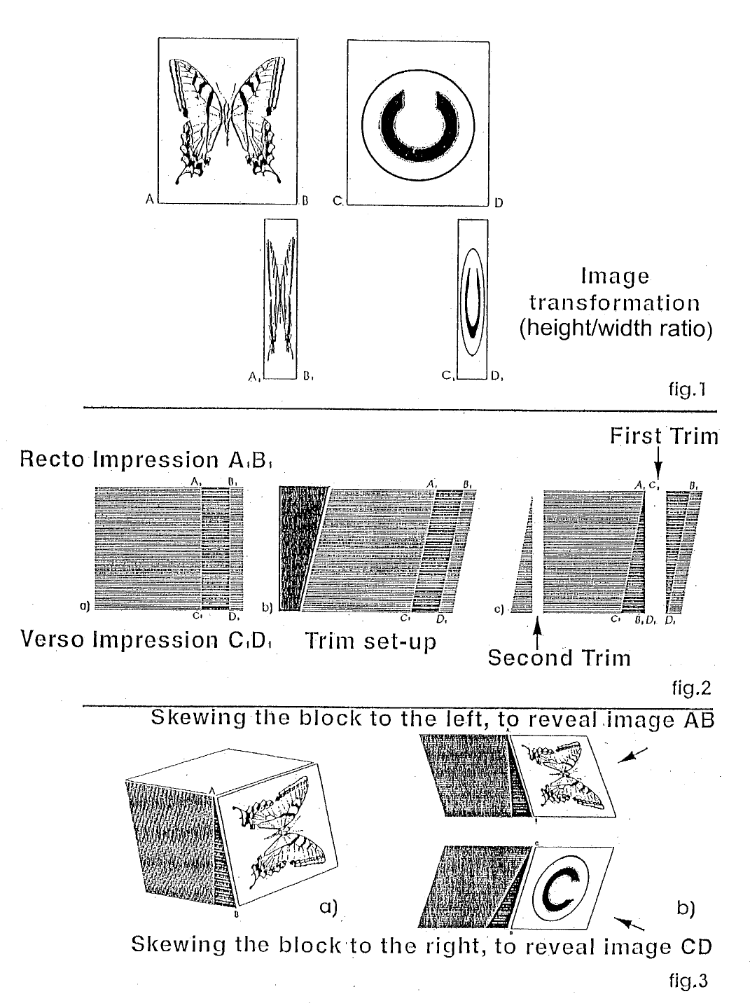

In the present invention, it is significant sometimes to carry out the compression of the images to be printed (P1.1 FIG. 1) in order to not block the finality of the object: books, magazines, diaries, note books, note pads, play cards, etc. . . . In the end, the image refinds its original dimension on the side of the paper block.

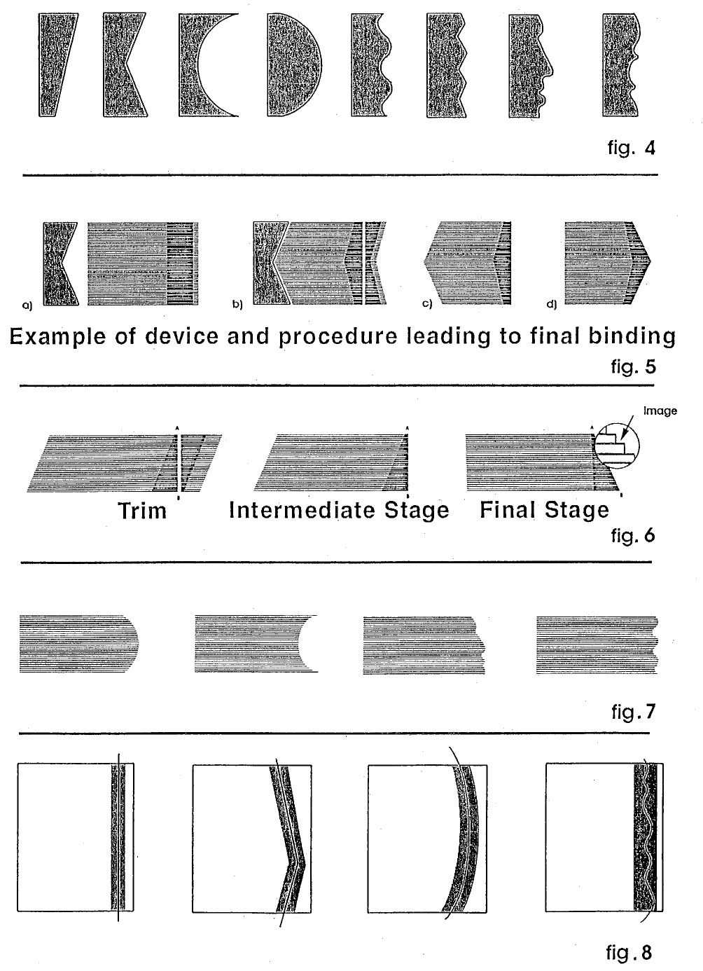

The images can undergo various deformations for different graphic purposes. The combination image-texts, initials or symbols can be carried out in a promotional goal, advertising, decorative, a pun or images such as for example, the recto impression of a winter landscape and on the verso the same landscape in summer. The introduction of a third image by impression on the section is possible. The process of alignment before the trimming can be done in various geometrical or figurative forms (P1.2 FIG. 4). The shift of the sheets can be carried out without form by other procedures and one can consider distorsions in the mass of paper or a repositioning of the sheets, one compared to another (example by rotation.) The purpose of the device in special forms is a specific deformation of the image and the will to mix it with a relief which lets the image be seen in a certain manner. After trimming, for a possible binding, it is necessary to readjust the sheets in right angle (P1.2 FIG. 7). In certain cases, a retrimming is necessary to recreate the parallelism of the volume of paper sheets (P1.1 FIG. 2c). In another case, one can connect without retrimming, while readjusting to 90° (P1.2 FIG. 6). This type of binding leaves visible the recto image, without torsion (P1.2 FIG. 6). Several combinations can leave visible entirely or partially the images in home position. One can forsee, in cases of productivity, the design of a press which modifies the position of the impression, breaks into leaf by sheet to thus carry out the skewing phase before trimming.

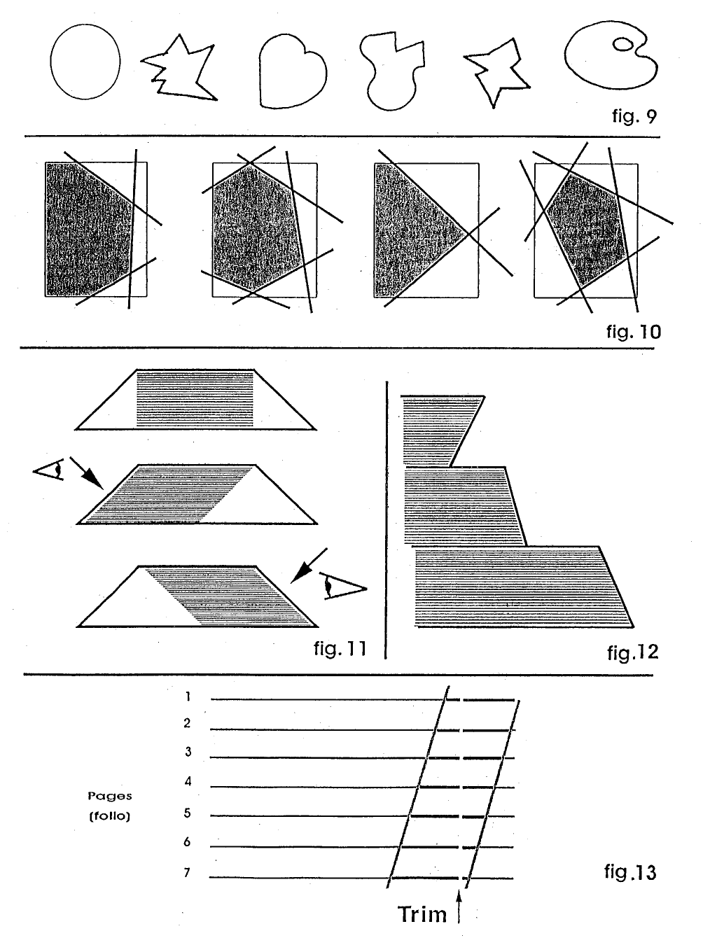

Trimming according to the design or for particular concepts, can be carried out with a blade right, curved, angular, etc. . . . (P1.2 FIG. 8) or with all other form of cutting (P1.3 FIG. 9).

The trimming can also be composed of several interventions or the combined interventions (P1.3 FIG. 10). The impression of the paper sheets, in this case, can comprise one or more images adapted to the interventions of cutting. In certain cases, the impressions and the trimming can be carried out on one, two or several sides and the operations impression-trimming followed by a second impression and of a retrimming on different places.

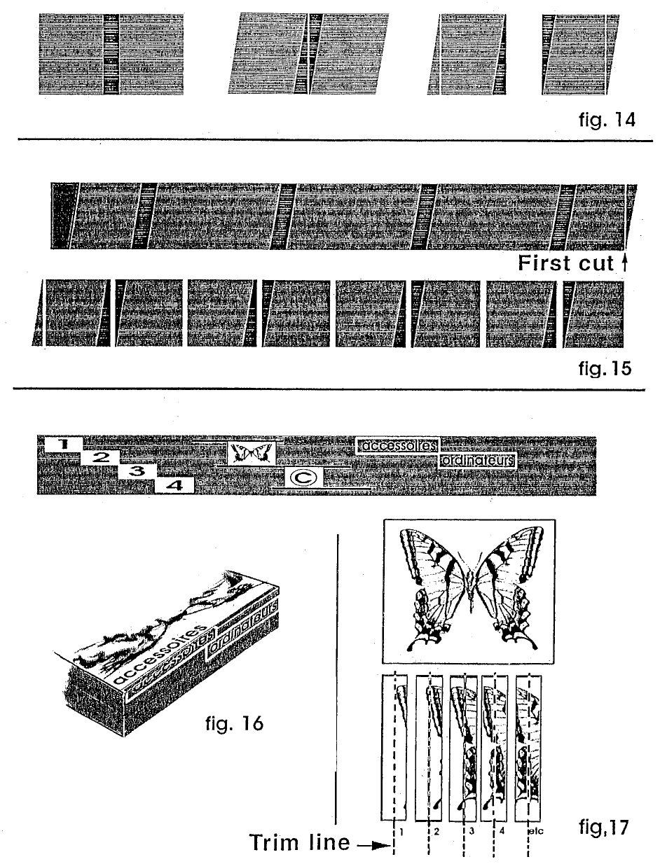

The objects can also be composed of several thicknesses of paper (P1.3 FIG. 12). The paper sheets can be free, glued or connected in all manners (before or after the trimming). The printed and trimmed blocks of paper can also be locked up in transparent boxes of different shapes, letting the images appear. The rigid or flexible boxes can leave by their design, paper to reposition itself in several ways (P1.3 FIG. 11). The imprint can be recto simple or to have the same image printed on the back, mirroring with the same co-ordinates. For aesthetic or practical reasons, the thickness of the blocks can be different and paper can have different weights. The sheets can be of different nature (ex: opaque plastic or transparency). Two objects can be carried out in the same block of paper and to profit from the same mirroring images (P1.4 FIG. 14). In the manufacturing process, one can obtain several objects from the same block of paper. Only one aligning device with a difrent than 90° angle, transmits the shift to the assambly. Then, the objects are separated by normal trimming at 90° (P1.4 FIG. 16). The printing of images on the trimming side, can be a remake on an already printed and stitched volume of paper, to improve its quality. For the extension of this invention on technological processes where the printing, stitching and the trimming are done at the same time, one simulates the process of skewing in the preparation with the printing. An image compressed or not, can be introduced into the formatting of a volume, be skewed systematically compared to the reference marks of cutting (P1.3 FIG. 13) and thus to envisage and break up the process of the invention for an equivalent result without movement of retiming before trimming (significant for the manufacture of books, magazine, catalogues etc . . .). The skewing will be made compared to the margin of cutting (principle of the lost bottom) in connection with the folio and the number of pages. One can have the same result to leave the image uncompressed, divided systematically in sections added in the formatting as in the preceding case (P1.4 FIG. 17).

In the present invention, one can envisage software which would allow the preparation of the image and the automatic introduction into a folio. The invention can be applied to catalogues of sale, telephone directories, dictionaries, diaries etc . . . , for information purposes, on the contents and its position in volume. The information can be graphic, image or text etc . . . In the case of text, the intervention can be complementary to the current method which is that of printing a text-advertiser on each page of a chapter (P1.4 FIG. 16). With the risk of worse quality, one can simulate the assembly process by printing or a shifted cutting, sheet by sheet. A solvent can be applied to improve the visibility of the image on the trimmed side. If, on the other hand, the image must be hidden, the side of the trimmed block of paper can be gilded.

1) Manufacturing process for the fabrication of blocks of sheet of paper carrying images on the side, characterized by the realigning of the trimmed block of sheet of paper print at an angle different than 90°, with the help of a device or by manual skewing, before trimming, so that in the plan of cutting, the image imerges, recomposed from successive stripps, and further evidenced by the skewing of the block of paper, before assembly or by torsion of block after assemblage or binding (FIG. 2) (FIG. a).

2) Manufacturing process, according to claim 1, characterized by the compression (optical) of the image before printing, on dimension corresponding to the trimming (FIG. 1), operation of which the goal is to use the minimum of surface on the paper sheet, the compression of the image being calculated according to the design, so as to recompose and find its dimensions in the section (FIG. 3 a).

3) Manufacturing process according to claims 1 and 2, characterized by recto/verso printing of the block of sheets of paper so as to be able to find the two images in the section of volume, in an alternative way (FIG. 3 b).

4) Manufacturing process according to claims 1, 2 and 3, characterized by the application on the section, after trimming, of a coat of paint or gilding, in order to hide the images which will only be visible by skewing the block of paper sheets.

5) Unspecified manufacturing process according to one of the preceding claims characterized by the rotation of the sheets of the block of paper, one compared to another, before or after the trimming, with an aim of generating deformations and anamorphoses of the image.

6) Manufacturing process according to claims 1, 2, 3 characterized by the cutting of the block of paper by means of a blade or a shaped knife (FIGS. 8 and 9).

7) Manufacturing process according to claims 1, 2 and 3, characterized by the realigning of the printed block of paper sheets, before or after trimming and binding, against an arbitrary form (FIGS. 4, 5 and 7).

8) Manufacturing process of fabrication according to the claims 1, 2 and 3, characterized by the substitution of the operation of realigning of the block of paper by the preparation with printing, sheet by sheet (folio), with successive trimmings of the image, of width sufficient, shift the one compared to other, with the trimming side, so that the image itself recomposes in the section (intend with the adaptation of the invention with the printing procesus complex e.g. store, catalogue, directory).
